(19) United States
(12) Patent Application Publication
(10) Pub. No.: US 2009/0136705 A1
(43) Pub. Date: May 28, 2009

(54) Oriented Molded Articles and Methods of Making and Using the Same

(76) Inventors: Guoqiang Mao, Smyrna, GA (US); Edward M. Kaucic, Newnan, GA (US); Kevin Sporrer, Newman, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 12/253,584

(22) Filed: Oct. 17, 2008

Related U.S. Application Data
(60) Provisional application No. 60/999,614, filed on Oct. 19, 2007.

(51) Int. Cl. B32B 3/06; B29C 39/00; B23P 17/04

(52) U.S. Cl. 428/99; 264/251; 29/428

(57) ABSTRACT

The present invention provides compositions and methods addressing the problems and disadvantages associated with orienting articles prior to disposition in a housing. Compositions and methods of the present invention, in some embodiments, can provide articles with the proper orientation for disposition in a housing without the encumbrances associated with hand assembly, such as increased production time and increased potential for contamination. As a result, manufacturers and users of products comprising polymeric articles disposed in housings are no longer restricted to the use of articles having isotropic shapes and homogeneous properties.

### RELATED APPLICATION DATA

The present application hereby claims priority under 35 U.S.C. § 119(e) to U.S. Provisional Patent Application Ser. No. 60/999,614 filed Oct. 19, 2007 which is hereby incorporated by reference in its entirety.

### FIELD OF THE INVENTION

The present invention relates to molded articles and, in particular, to molded polymeric articles.

### BACKGROUND OF THE INVENTION

Polymeric articles have been widely used in immobilization, filtration, and fluid barrier applications. Most devices incorporating polymeric articles in the foregoing capacities comprise a housing in which the polymeric article is disposed. Assembly of polymeric articles into housings can be a labor intensive process, especially in situations wherein the polymeric articles require proper orientation before housing insertion. Orientation of a polymeric article prior to placement in a housing often requires hand assembly, which increases the time and cost. Moreover, in some applications such as medical devices and sensitive analytical devices, hand orientation of polymeric articles is not acceptable due to the potential of contamination of the articles.

In order to avoid orientation of a polymeric article prior to placement in a housing, manufacturers often choose articles having isotropic shapes, even if the isotropic shape is not an advantageous choice for the finished product. A manufacturer, for example, may choose to use a disc or cylinder shape as a pipette tip filter or barrier wherein the pipette tip comprises a conical geometry.

Moreover, the aversion to orienting an article prior to disposition in a housing precludes manufacturers from taking advantage of polymeric articles having heterogeneous properties, such as a heterogeneous porosity. A pipette tip filter, for example, may advantageously display a small pore size proximate the sample collection chamber of the pipette tip and a larger pore size distal to the sample collection chamber. Such an arrangement can minimize problems associated with pressure drop across the pipette tip filter. A manufacturer, nevertheless, may decline such an arrangement in order to avoid orienting the small pore size section of the pipette tip filter proximate the sample collection chamber in the pipette tip.

In view of the foregoing, it would be desirable to provide compositions comprising polymeric articles operable to address problems associated with article orientation in housings.

### SUMMARY

The present invention provides compositions and methods addressing the problems and disadvantages associated with orienting articles prior to disposition in a housing. Compositions and methods of the present invention, in some embodiments, can provide articles with the proper orientation for disposition in a housing without the encumbrances associated with hand assembly, such as increased production time and increased potential for contamination. As a result, manufacturers and users of products comprising polymeric articles disposed in housings are no longer restricted to the use of articles having isotropic shapes and homogeneous properties.

In one embodiment, the present invention provides a composite composition comprising a sheet comprising at least one aperture and at least one molded article, wherein the at least one molded article is at least partially disposed in the at least one aperture. In some embodiments, a composite composition comprises a sheet comprising a plurality of apertures, wherein each of the plurality of apertures comprises a molded article at least partially disposed therein. A sheet, in one embodiment, comprises an array of apertures.

A molded article, in some embodiments, is disposed in the aperture of a sheet in the proper orientation for placement in a housing. In some embodiments, a molded article being disposed in the proper orientation for placement in a housing, as described further herein, precludes the need or requirement of further orienting the molded article once the molded article is disengaged from the sheet for placement into the housing.

In another embodiment, the present invention provides a composite composition comprising a sheet comprising at least one raised surface and at least one molded article, wherein the at least one molded article is associated with the at least one raised surface. In one embodiment, the at least one molded article is associated with the at least one raised surface by mechanical engagement, such as frictional engagement. In some embodiments, the sheet of a composite composition comprises a plurality of raised surfaces, wherein each of the plurality of raised surfaces has a molded article associated therewith. A molded article, in some embodiments, is associated with the raised surface of a sheet in a proper orientation for placement into a housing. In some embodiments, a molded article being associated with the surface in the proper orientation for placement in a housing precludes the need to or requirement for further orienting the molded article once the molded article is disengaged from the surface for placement into the housing.

Molded articles, in some embodiments of the present invention, comprise molded polymeric articles. In some embodiments, molded polymeric articles comprise sintered polymeric articles. Molded polymeric articles, including sintered polymeric articles, in some embodiments, are porous. Moreover, molded articles of the present invention can have any desired shape. In one embodiment, molded articles comprises anisotropic or asymmetric shapes. In another embodiment, molded articles comprise isotropic, spherical, or symmetrical shapes. Additionally, molded articles, in some embodiments, comprise heterogeneous compositions and/or heterogeneous physical properties such as compositional gradients or porosity gradients.

Molded sintered porous polymeric articles, in some embodiments of the present invention, comprise immobilization, filtration, or barrier media for various applications. Molded sintered porous polymeric articles, for example, can comprise barrier media for use in pipette tips or filtration media for use in a wide variety of filtration apparatus.

Sheets comprising at least one aperture or raised surface, according to embodiments of the present invention, can comprise any desired material. In some embodiments, a sheet comprising at least one aperture comprises a polymeric material. Polymeric materials suitable for serving as a sheet can comprise polyesters, polyamides, polyethylene, polypropylene, cellulose based sheets, elastomers, paper, or combinations thereof. In another embodiment, a sheet comprising at least one aperture or raised surface is a non-woven sheet or a woven sheet. In a further embodiment, a sheet comprises a metal such as a metal foil, including aluminum foil.

Moreover, sheets can be rigid or flexible. In some embodiments wherein a sheet is flexible, the sheet can be formed into a roll. In some embodiments, a sheet can be formed into a roll after one or more molded articles have been disposed in apertures or on raised surfaces of the sheet. Additionally, sheets for use in embodiments of the present invention can have any desired thickness. In one embodiment, a sheet comprising at least one aperture has a thickness ranging from 1 mil to 50 mil, from about 2 mil to about 20 mil, or from about 5 mil to about 10 mil. In another embodiment, a sheet has a thickness less than about 1 mil or greater than about 50 mil.

Sheets, according to embodiments of the present invention, can have any arrangement of apertures or raised surfaces for interaction with molded articles. In one embodiment, a sheet comprises a strip of sequential apertures or raised surfaces. In another embodiment, a sheet comprises a two-dimensional array of apertures or raised surfaces.

In another aspect, the present invention provides methods of making composite compositions. In one embodiment, a method of making a composite composition comprises providing a sheet comprising at least one aperture and disposing at least one molded article in the at least one aperture. In some embodiments, the molded article is disposed in the aperture in an proper orientation for insertion in a housing.

Disposing a molded article in an aperture of a sheet, according to one embodiment, comprises forming the molded article in the aperture. Forming a molded article in an aperture of a sheet, in some embodiments, comprises providing a first mold comprising a first cavity and filling the first cavity with a first moldable material. The aperture of the sheet is aligned with the first cavity and a second mold comprising a second cavity is provided. The second cavity of the second mold is aligned with the first cavity and is filled with a second moldable material. After filling the second cavity, the molded article is formed in the aperture of the sheet. The sheet comprising the aperture, according to the present embodiment, comprises a material sufficient to withstand melting or any other degradative processes produced by the molding of the molded article. In some embodiments, the first moldable material and the second moldable material are the same. In other embodiments, the first moldable material and the second moldable material are different.

In one embodiment, for example, particles of a first polymeric material are provided in the first cavity of the first mold and an aperture of a polyester sheet is aligned with the first cavity. The second cavity of the second mold is aligned with the first cavity and filled with particles of a second polymeric material. The first and second molds are heated to sinter the first and second polymeric particles to form a continuous porous polymeric article disposed in the aperture of the polyester sheet.

In another embodiment, disposing a molded article in an aperture of a sheet comprises forming the molded article in a mold, the mold comprising a first cavity and a second cavity, removing the first or second cavity to expose a section of the molded article, and positioning the aperture of the sheet around the exposed section of the molded article. Forming the molded article, according to the present embodiment, can comprise filling the first cavity with a first moldable material, filling the second cavity with a second moldable material, and molding the first and second moldable materials.

In some embodiments wherein the aperture of the sheet is placed around the molded article after molding, the sheet is not required to demonstrate any heat resistant or other degradation resistant properties as the sheet is not in contact with the mold during the molding process. Moreover, in some embodiments, the sheet comprising at least one aperture may have elastomeric properties to permit deformation of the sheet and aperture to facilitate placement of the aperture around the molded article.

As provided herein, disposing the molded article in the aperture of a sheet while still in the mold by molding the article in the aperture or placing the aperture around the molded article, in some embodiments, provides the molded article with the proper orientation for subsequent placement in a housing. Moreover, disposing the molded article in the aperture of a sheet while still in the mold facilitates removal of the molded article from the mold. As the molded article is disposed in the aperture of the sheet by mechanical engagement, the sheet can be pulled from the mold to remove the articles from the mold cavities.

In some embodiments, a plurality of molded articles can be simultaneously disposed in a plurality of apertures in a sheet. A mold, in one embodiment, for example, can display an array of cavities for the formation of a plurality of molded articles. A sheet having a plurality of apertures corresponding to the array of cavities is utilized for the simultaneous disposition of the plurality of molded articles in the apertures.

Additionally, in some embodiments, methods of making composite compositions of the present invention can be continuous. A section of a continuous sheet comprising an array of apertures corresponding to an array of cavities in a mold is provided. The molded articles are disposed in the apertures of the section of the continuous sheet according to the methods described herein. The section comprising the apertures with molded articles disposed therein is subsequently advanced from the mold, and a new section of the continuous sheet comprising the array of apertures is presented for disposing newly molded articles in the array of apertures. The foregoing process can be repeated any number of times. The resulting continuous sheet comprising a continuous array of apertures having molded articles disposed therein can be rolled into a roll or cut into sections for stacking.

In another embodiment, a method of making a composite composition comprises providing a sheet comprising at least one raised surface, forming a molded article in a mold comprising a first cavity, and associating the at least one raised surface with the at least one molded article. Associating the at least one raised surface with the at least one molded article, in some embodiments, comprises mechanically engaging the molded article with the raised surface. In one embodiment, for example, a raised surface of the sheet comprises a cylindrical protrusion or pin. The cylindrical protrusion is operable to mechanically engage a cylindrical depression in the molded article. The mechanical engagement between the protrusion and depression may be a friction fit.

In some embodiments, a plurality of molded articles can be simultaneously associated with a plurality of raised surfaces in a sheet. A mold, in one embodiment, for example, can display an array of cavities for the formation of a plurality of molded articles, and a sheet can demonstrate a plurality of raised surfaces corresponding to the array of cavities. The plurality of raised surfaces are simultaneously brought into contact with the plurality of molded articles to form a composition of the present invention. Moreover, the foregoing process can be continuous wherein segments of a continuous sheet of raised surfaces are sequentially brought into contact with newly molded articles. As provided herein, the continuous sheet of raised surfaces and associated molded articles can be subsequently rolled or cut into individual segments and stacked.

Associating a molded article with a raised surface of a sheet while still in the mold, in some embodiments, provides the molded article with the proper orientation for subsequent placement into a housing. Moreover, associating a molded article with the raised surface of a sheet while still in the mold facilitates removal of the molded article from the mold. As the molded article can be associated with a raised surface of the sheet by mechanical engagement, the sheet can be pulled from the mold to remove the articles from the mold cavities.

In a further aspect, the present invention provides methods of disposing a molded article in a housing. In one embodiment, a method of disposing a molded article in a housing comprises providing a composition comprising a sheet comprising at least one aperture and at least one molded article, wherein the molded article is at least partially disposed in the at least one aperture. The aperture and the molded article disposed therein are aligned with an opening of a housing and the molded article is separated or disengaged from the aperture for disposition in the housing. In some embodiments, the molded article is separated or disengaged from the aperture in the sheet by pushing or pulling the molded article.

In another embodiment, methods of the present invention provide for the disposition of a plurality of molded articles into a plurality of housings. As provided herein, in some embodiments, a sheet comprises a plurality of apertures, wherein each of the plurality of apertures comprises a molded article disposed therein. The plurality of apertures and plurality of associated molded articles are aligned with a plurality of housings. The plurality of molded articles are separated or disengaged from the apertures for disposition in the housings. In some embodiments, the plurality of molded articles are disposed in the plurality of housings simultaneously. In other embodiments, the plurality of molded articles are disposed in the plurality of housings sequentially or serially.

In another aspect, a method of disposing a molded article in a housing comprises providing a composition comprising a sheet comprising at least one raised surface and at least one molded article associated with the raised surface and aligning the raised surface and molded article with an opening of a housing. Following alignment, the molded article is separated or disengaged from the raised surface of the sheet for disposition in the housing. Separation or disengagement of the molded article from the raised surface can comprise pushing or pulling the molded article from the raised surface.

Moreover, a plurality of molded articles, in some embodiments, can be disposed in a plurality of housings. In one embodiment, a sheet comprises a plurality of raised surfaces, wherein each raised surface has a molded article associated therewith. The plurality of raised surfaces and molded articles are aligned with a plurality of housings, and the molded articles are separated from the raised surfaces for disposition in the plurality of housings.

As provided herein, in some embodiments, molded articles having anisotropic shapes, heterogeneous compositions, and/or heterogeneous physical properties can be placed into the proper orientation for disposition in a housing when the molded article is disposed in an aperture of a sheet or otherwise associated with a raised surface of the sheet. The preorientation of the molded article in the sheet prior to placement in a housing precludes the disadvantages associated with hand orienting mold articles thereby freeing manufacturers to design molded articles with complicated shapes, compositions, and properties to match the demands of various end use applications.

Housings, according to some embodiments of the present invention, comprise pipette tips, syringes, tubes, well plates such as a 96-well plate or any multiple thereof, separation columns, or filter housings.

These and other embodiments are presented in greater detail in the detailed description which follows.

### BRIEF DESCRIPTION OF THE FIGURES

FIG. 1 illustrates a perspective view of a composite composition according to one embodiment of the present invention.

FIG. 2 illustrates a perspective view of a molded article according to one embodiment of the present invention.

FIG. 3 illustrates a perspective view of a molded article according to one embodiment of the present invention.

FIG. 4 illustrates a perspective view of a molded article according to one embodiment of the present invention.

FIG. 5 illustrates a perspective view of a molded article according to one embodiment of the present invention.

FIGS. 6(a)-(c) illustrate a method of disposing a plurality of molded articles in a plurality of apertures in a sheet according to one embodiment of the present invention.

FIGS. 7(a)-(d) illustrate a method of disposing a plurality of molded articles in a plurality of housings according one embodiment of the present invention.

FIG. 8 illustrates a molded article disposed in a housing according to one embodiment of the present invention.

### DETAILED DESCRIPTION

The present invention provides compositions and methods addressing the problems and disadvantages of orienting polymeric articles prior to disposition in a housing. Compositions and methods of the present invention, in some embodiments, can permit articles to be placed into the proper orientation for disposition in a housing without the encumbrances associated with hand assembly. As a result, manufacturers and users of products comprising polymeric articles disposed in housings are no longer restricted to the use of articles having isotropic shapes and homogeneous properties.

In one embodiment, the present invention provides a composite composition comprising a sheet comprising at least one aperture and at least one molded article, wherein the at least one molded article is at least partially disposed in the at least one aperture. In some embodiments, a composite composition comprises a sheet comprising a plurality of apertures, wherein each of the plurality of apertures comprises a molded article at least partially disposed therein. A sheet, in one embodiment, comprises an array of apertures. A molded article, in some embodiments, is disposed in an aperture of a sheet in the proper orientation for placement into a housing.

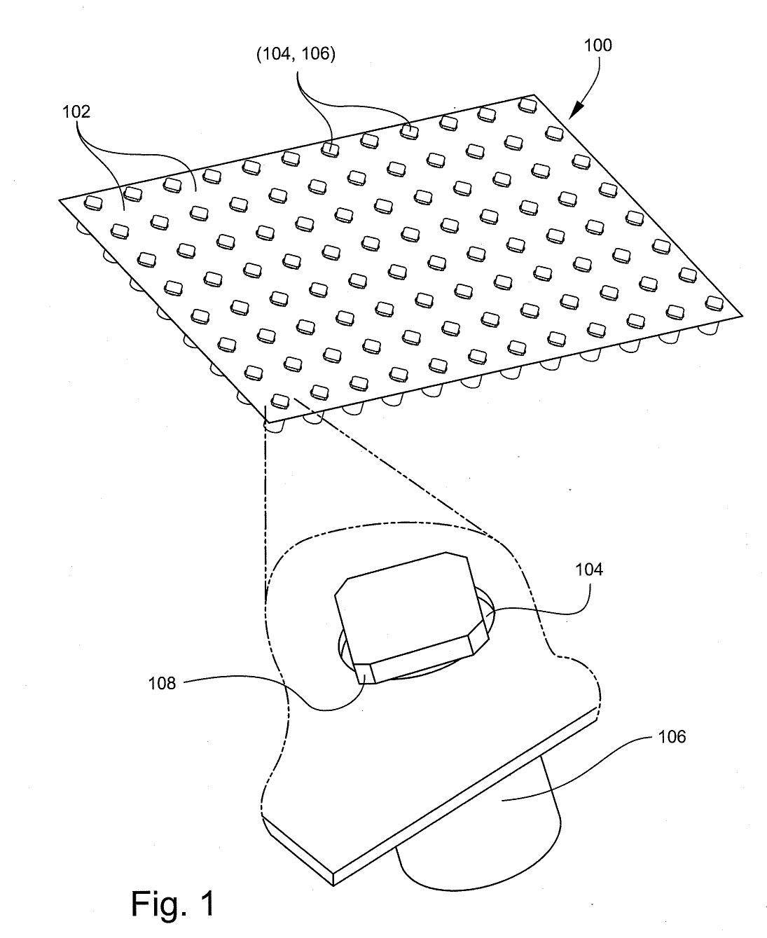

FIG. 1 illustrates a composite composition according to one embodiment of the present invention. As illustrated in FIG. 1, the composite composition (100) comprises a sheet (102) comprising a plurality of apertures (104) arranged in a two dimensional array. Each of the plurality of apertures (104) comprises a molded article (106) disposed therein. In the embodiment illustrated in FIG. 1, the molded articles (106) are at least partially disposed in the apertures (104) by mechanical engagement. A flange (108) of the molded article (106), for example, engages a surface of the sheet (102) thereby retaining the molded article (106) in the aperture (104).

In another embodiment, the present invention provides a composite composition comprising a sheet comprising at least one raised surface and at least one molded article, wherein the at least one molded article is associated with the at least one raised surface. In one embodiment, the at least one molded article is associated with the at least one raised surface of the sheet by mechanical engagement, such as frictional engagement. In some embodiments, the sheet of a composite composition comprises a plurality of raised surfaces, wherein each of the plurality of raised surfaces has a molded article associated therewith. A molded article, in some embodiments, is associated with the raised surface of a sheet in an proper orientation for placement into a housing.

Turning now to components that can be included in composite compositions of the present invention, composite compositions of the present invention comprise a sheet comprising at least one aperture or raised surface.

### Sheets

Sheets comprising at least one aperture or raised surface, according to embodiments of the present invention can comprise any desired material. In some embodiments, a sheet comprising at least one aperture or raised surface comprises a polymeric material. Polymeric materials suitable for serving as a sheet can comprise polyesters, polyamides, polyethylene, polypropylene, cellulose based sheets, elastomers, paper, or combinations thereof. In one embodiment, a sheet comprises biaxially oriented polyethylene terephthalate (MYLAR®). In another embodiment, sheet comprising at least one aperture or raised surface is a non-woven sheet or a woven sheet. In a further embodiment, a sheet comprises a metal such as a metal foil, including aluminum foil.

Moreover, sheets can be rigid or flexible. In some embodiments wherein a sheet is flexible, the sheet can be formed into a roll. In some embodiments, a sheet can be formed into a roll after one or more molded articles have been disposed in apertures or associated with raised surfaces of the sheet. Additionally, sheets for use in embodiments of the present invention can have any desired thickness. In one embodiment, a sheet comprising at least one aperture has a thickness ranging from 1 mil to 50 mil, from about 2 mil to about 20 mil, or from about 5 mil to about 10 mil. In another embodiment, a sheet comprising at least one aperture has a thickness less than about 1 mil and greater than about 50 mil.

Sheets, according to embodiments of the present invention, can have any arrangement of apertures or raised surfaces for interaction with molded articles. In one embodiment, a sheet comprises a strip of sequential apertures or raised surfaces. In another embodiment, a sheet comprises a two-dimensional array of apertures or raised surfaces for receiving molded articles.

In some embodiments, an aperture in the sheet can have any desired shape including circular, triangular, square, rectangular, elliptical or polygonal. Moreover, in some embodiments, an aperture in the sheet has a shape divergent from the shape of the molded article disposed in the aperture. In some embodiments, a raised surface can have any desired shape operable to engage a molded article. In some embodiments, a raised surface has a cylindrical, spherical, elliptical, triangular, square, rectangular or polygonal shape.

### Molded Articles

In addition to sheets comprising at least one aperture or at least one raised surface, composite compositions of the present invention comprise at least one molded article. Molded articles for use in embodiments of the present invention can have any desired shape. In one embodiment, molded articles comprise anisotropic or asymmetric shapes. As provided herein, molded articles comprising anisotropic or asymmetric shapes, when disposed in an aperture of a sheet or associated with a raised surface of a sheet, display the proper orientation for placement in a housing. In another embodiment, molded articles comprise isotropic, symmetrical, or spherical shapes. Additionally, molded articles, in some embodiments, comprise heterogeneous compositions and/or heterogeneous physical properties such as compositional gradients or porosity gradients.

In one aspect, molded articles of the present invention comprise polymeric materials, including sintered porous polymeric materials. Molded articles comprising sintered porous polymeric materials can demonstrate advantageous chemical and mechanical properties, such as resistance to solvents, and increased flexibilities, thereby facilitating application of these materials in a variety of fields including immobilization, filtration, or barrier media.

In one embodiment, a sintered porous polymeric material of a molded article comprises at least one plastic. In another embodiment, a sintered porous polymeric material comprises a plurality of plastics. In another aspect, a sintered porous polymeric material of a molded article comprises at least one plastic and at least one elastomer. In some embodiments, a sintered porous polymeric material comprises a plurality of plastics and at least one elastomer. In a further embodiment, a sintered porous polymeric material of a molded article comprises at least one plastic and a plurality of elastomers.

Furthermore, in some embodiments, a sintered porous polymeric material of a molded article comprises a flexible region continuous with a rigid region, wherein the flexible region comprises a first plastic and at least one elastomer and the rigid region comprises a second plastic.

Turning now to components that can be included in sintered polymeric materials of molded articles of the present invention, sintered polymeric materials of the present invention, in some embodiments, comprise at least one plastic.

### Plastics

In some embodiments, sintered polymeric materials of the present invention comprise a plurality of plastics. Plastics, as used herein, include flexible plastics and rigid plastics. Flexible plastics, in some embodiments, comprise polymers possessing moduli ranging from about 15,000 N/cm² to about 350,000 N/cm² and/or tensile strengths ranging from about 1500 N/cm² to about 7000 N/cm². Rigid plastics, according to some embodiments, comprise polymers possessing moduli ranging from about 70,000 N/cm² to about 350,000 N/cm² and have tensile strengths ranging from about 3000 N/cm² to about 8500 N/cm².

Plastics suitable for use in sintered polymeric materials of the present invention, in some embodiments, comprise polyolefins, polyamides, polyesters, rigid polyurethanes, polyacrylonitriles, polycarbonates, polyvinylchloride, polymethylmethacrylate, polyvinylidene fluoride, polytetrafluoroethylene, polyethersulfones, polystyrenes, polyether imides, polyetheretherketones, polysulfones, and combinations and copolymers thereof.

In some embodiments, a polyolefin comprises polyethylene, polypropylene, and/or copolymers thereof. Polyethylene, in one embodiment, comprises high density polyethylene (HDPE). High density polyethylene, as used herein, refers to polyethylene having a density ranging from about 0.92 g/cm³ to about 0.97 g/cm³. In some embodiments, high density polyethylene has a degree of crystallinity (% from density) ranging from about 50 to about 90. In another embodiment, polyethylene comprises ultrahigh molecular weight polyethylene (UHMWPE). Ultrahigh molecular weight polyethylene, as used herein, refers to polyethylene having a molecular weight greater than 1,000,000.

### Elastomers

In addition to at least one plastic, sintered polymeric materials of molded articles of the present invention, in some embodiments, comprise at least one elastomer. Sintered polymeric materials, according to some embodiments, comprise a plurality of elastomers. Elastomers suitable for use in sintered polymeric materials of the present invention, in one embodiment, comprise thermoplastic elastomers (TPE). Thermoplastic elastomers, in some embodiments, comprise polyurethanes and thermoplastic polyurethanes (TPU). Thermoplastic polyurethanes, in some embodiments, include multiblock copolymers comprising a polyurethane and a polyester or polyether.

In other embodiments, elastomers suitable for use in sintered porous polymeric materials of the present invention comprise polyisobutylene, polybutenes, butyl rubber, or combinations thereof. In another embodiment, elastomers comprise copolymers of ethylene and other polymers such as polyethylene-propylene copolymer, referred to as EPM, ethylene-butene copolymer, polyethylene-octene copolymer, and polyehtylene-hexene copolymer. In a further embodiment, elastomers comprise chlorinated polyethylene or chloro-sulfonated polyethylene.

In some embodiments, elastomers suitable for use in sintered porous polymeric materials of the present invention comprise 1,3-dienes and derivatives thereof. 1,3-dienes include styrene-1,3-butadiene (SBR), styrene-1,3-butadiene terpolymer with an unsaturated carboxylic acid (carboxylated SBR), acrylonitrile-1,3-butadiene (NBR or nitrile rubber), isobutylene-isoprene, cis-1,4-polyisoprene, 1,4-poly(1,3-butadiene), polychloroprene, and block copolymers of isoprene or 1,3-butadiene with styrene such as styrene-ethylene-butadiene-styrene (SEBS). In other embodiments, elastomers comprise polyalkene oxide polymers, acrylics, or polysiloxanes (silicones) or combinations thereof.

In a further embodiment, elastomers suitable for use in sintered polymeric materials of the present invention, in some embodiments, comprise FORPRENE®, LAPRENE®, SKYPEL®, SKYTHANE®, SYNPRENE®, RIMFLEX®, Elexar, FLEXALLOY®, TEKRON®, DEXFLEX®, Typlax, Uceflex, ENGAGE®, HERCUPRENE®, Hi-fax, Novalene, Kraton, Muti-Flex, EVOPRENE®, HYTREL®, NORDEL®, VITON®, Vector, SILASTIC®, Santoprene, Elasmax, Affinity, ATTANE®, SARLINK®, etc.

### Sintered Polymeric Materials Comprising at Least One Plastic

A sintered porous polymeric material of a molded article, in some embodiments, comprises at least one plastic. In other embodiments, a sintered porous polymeric material comprises a plurality of plastics. In one embodiment, a sintered porous polymeric material comprising at least one plastic does not comprise an elastomer.

In some embodiments, a sintered porous polymeric material comprising at least one plastic has a porosity ranging from about 10% to about 90%. In other embodiments, a sintered porous polymeric material has a porosity ranging from about 20% to about 80% or from about 30% to about 70%. In another embodiment, a sintered porous polymeric material comprising at least one plastic has a porosity ranging from about 40% to about 60%.

In some embodiments, a sintered porous polymeric material comprising at least one plastic has an average pore size ranging from about 1 μm to about 200 μm. In other embodiments, a sintered porous polymeric component has an average pore size ranging from about 2 μm to about 150 μm, from about 5 μm to about 100 μm, or from about 10 μm to about 50 μm. In another embodiment, a sintered porous polymeric material comprising at least one plastic has an average pore size ranging from about 0.1 μm to about 1 μm. In a further embodiment, a sintered porous polymeric material has an average pore size greater than about 200 μm. In one embodiment, a sintered porous polymeric material has an average pore size ranging from about 200 μm to about 500 μm or from about 500 μm to about 1 mm.

A sintered porous polymeric material comprising at least one plastic, according to some embodiments, has a density ranging from about 0.1 g/cm³ to about 1 g/cm³. In other embodiments, a sintered porous polymeric material has a density ranging from about 0.2 g/cm³ to about 0.8 g/cm³ or from about 0.4 g/cm³ to about 0.6 g/cm³. In a further embodiment, a sintered porous polymeric material has a density greater than about 1 g/cm³. In one embodiment, a sintered porous polymeric material has density less than about 0.1 g/cm³.

In some embodiments, a sintered porous polymeric material comprising at least one plastic has a rigidity according to ASTM D747 of greater than about 15 pounds. In other embodiments, a sintered porous polymeric material has a rigidity according to ASTM D747 of greater than 10 pounds. In another embodiment, the sintered porous polymeric material has a rigidity of according to ASTM D747 of greater than 5 pounds.

In some embodiments, a sintered porous polymeric material of a molded article comprising at least one plastic further comprises at least one color change indicator. In some embodiments, a color change indicator comprises an organic or inorganic dye, including food grade dyes. Color change indicators comprising food grade dyes, according to embodiments of the present invention, are operable to be used with biological samples due to the non-toxic nature of the food dyes.

In some embodiments, a color change indicator comprises FD&C Blue No. 1, FD&C Blue No. 2, FD&C Green No. 3, FD&C Red No. 40, FD&C Red No. 3, FD&C Yellow No. 5, FD&C Yellow No. 6, Solvent Red 24, Solvent Red 26, Solvent Red 164, Solvent Yellow 124, Solvent Blue 35, or combinations thereof.

Color change indicators, according to some embodiments, demonstrate a pH dependency on the color produced. As a result, color change indicators, in some embodiments, indicate not only liquid contact with the sintered porous polymeric material of the applicator but the relative pH of the contacting liquid as well. Color change indicators demonstrating a pH dependency, in some embodiments, comprise methyl violet, eosin yellow, malachite green, thymol blue, methyl yellow, bromophenol blue, congo red, methyl orange, bromocresol green, methyl red, litmus, bromocresol purple, bromophenol red, bromothymol blue, phenol red, neutral red, naphtholphthalein, cresol red, phenolphthalein, thymolphthalein, alkali blue, Alizarin Yellow R, indigo carmine, epsilon blue, or combinations thereof.

In some embodiments, a sintered porous polymeric material of a molded article comprises at least one color change indicator in an amount ranging from about 0.001 weight percent to about 2 weight percent. In other embodiments, a sintered porous polymeric material comprises at least one color change indicator in an amount ranging from about 0.01 weight percent to about 1 weight percent. In a further embodiment, a sintered porous polyemric material comprises at least one color change indicator in an amount ranging from about 0.05 weight percent to about 0.5 weight percent.

In some embodiments, a sintered porous polymeric material of a molded article comprising at least one plastic further comprises at least one super-absorbent material. In some embodiments, super-absorbent materials comprise hydrolyzed starch acrylonitrile graft copolymer, neutralized starch-acrylic acid graft copolymer, saponified acrylic acid ester-vinyl acetate copolymer, hydrolyzed acrylonitrile copolymer, acrylamide copolymer, modified cross-linked polyvinyl alcohol, neutralized self-crosslinking polyacrylic acid, crosslinked polyacrylate salts, neutralized crosslinked isobutylene-maleic anhydride copolymers, and salts and mixtures thereof. Super-absorbent materials, in some embodiments, comprise those disclosed by U.S. Pat. Nos. 5,998,032, 5,939,086, 5,836,929, 5,824,328, 5,797,347, 5,750,585, 5,175,046, 4,820,577, 4,724,114, and 4,443,515. Examples of commercially available super-absorbent materials comprise AP80HS, available from Stockhousen of Tuscaloosa, AL, and HYSORB® P7200, available from BASF of Budd Lake, N.J.

In some embodiments, a super-absorbent material comprises particles, fibers, or mixtures thereof. Particulate super-absorbent materials, in some embodiments, have average sizes ranging from about 1 μm to about 1 mm. In another embodiment, super-absorbent particles have an average size ranging from about 10 μm to about 900 μm, from about 50 μm to about 500 μm, or from about 100 μm to about 300 μm. In a further embodiment, super-absorbent particles have an average size less than about 1 μm or greater than about 1 mm.

Moreover, super-absorbent fibers, in some embodiments, have an average diameter ranging from about 1 μm to about 1 mm or from about 10 μm to about 750 μm. In another embodiment, super-absorbent fibers have an average diameter ranging from about 50 μm to about 500 μm, from about 100 μm to about 400 μm or from about 200 μm to about 300 μm. Super-absorbent fibers, in some embodiments, have a length ranging from about 100 μm to about 2.5 cm or from about 250 μm to about 1 cm. In another embodiment, super-absorbent fibers have a length ranging from about 500 μm to about 1.5 mm or from about 750 μm to about 1 mm.

In some embodiments, a sintered porous polymeric material of a molded article comprises at least one super-absorbent material in an amount ranging from about 10 weight percent to about 90 weight percent. In other embodiments, a sintered porous polymeric material comprises at least one super-absorbent material in an amount ranging from about 20 weight percent to about 80 weight percent. In another embodiment, a sintered porous polymeric material comprises at least one super-absorbent material in an amount ranging from about 30 weight percent to about 70 weight percent. In a further embodiment, a sintered porous polymeric material comprises at least one super-absorbent material in an amount ranging from about 40 weight percent to about 60 weight percent.

Super-absorbent materials, in some embodiments, are incorporated into the sintered porous matrix of the polymeric material. In other embodiments, super-absorbent materials are located in the pores of the sintered porous polymeric material of a molded article. In one embodiment, a super-absorbent material resides in the majority of the pores of the sintered porous polymeric material of a molded article. In another embodiment, a super-absorbent material resides in the minority of pores of the sintered porous polymeric material of a molded article. In a further embodiment, super-absorbent materials are located in both the sintered porous matrix and the pores of the sintered porous polymeric material of a molded article.

In some embodiments, a sintered porous polymeric material of a molded article comprising at least one plastic further comprises at least one functional additive. A functional additive, in some embodiments, comprises an ion exchange resin, such as anionic or cationic exchange resins. Ion exchange resins, in one embodiment, comprise the same disclosed by U.S. Pat. No. 6,710,093. Examples of commercially available ion exchange resins are DOWEX® from Dow Chemicals of Midland, Mich. and AMBERLITE® from Rohm & Haas of Philadelphia, Pa.

Functional additives, in some embodiments, comprise particles having surface functional groups. In one embodiment, functional additives comprise the same disclosed in U.S. Pat. No. 6,808,908. In another embodiment, functional additives comprise inorganic particles including silica powder, chopped glass fiber, glass beads, bioglasses, controlled porous glass (CPG), glass bubbles, alumina oxide, or mixtures thereof. Moreover, in some embodiments, inorganic function additives are modified with organic functional groups such as organosilanes or C₁₂ or C₁₈ alkyl chains.

Functional additives, in some embodiments, have an average particle size ranging from about 1 μm to about 1 mm. In another embodiment, functional additives have an average particle size ranging from about 10 μm to about 900 μm, from about 50 μm to about 500 μm, or from about 100 μm to about 300 μm. In a further embodiment, functional additives have an average particle size less than about 1 μm or greater than about 1 mm.

In some embodiments, a sintered porous polymeric material of a molded article comprising at least one plastic comprises at least one functional additive in an amount ranging from about 10 weight percent to about 90 weight percent. In other embodiments, a sintered porous polymeric material comprises at least one functional additive in an amount ranging from about 20 weight percent to about 80 weight percent. In another embodiment, a sintered porous polymeric material comprises at least one functional additive in an amount ranging from about 30 weight percent to about 70 weight percent. In a further embodiment, a sintered porous polymeric material comprises at least one functional additive in an amount ranging from about 40 weight percent to about 60 weight percent.

Functional additives, in some embodiments, are incorporated into the sintered porous matrix of the polymeric material. In other embodiments, functional additives are located in the pores of the sintered porous polymeric material of a molded article. In one embodiment, a functional additive resides in the majority of the pores of the sintered porous polymeric material of a molded article. In another embodiment, a functional additive resides in the minority of pores of the sintered porous polymeric material of a molded article. In a further embodiment, functional additives are located in both the sintered porous matrix and the pores of the sintered porous polymeric material of a molded article.

### Sintered Polymeric Materials Comprising at Least One Elastomer

In another aspect, a sintered porous polymeric material of a molded article comprises at least one plastic and at least one elastomer. Plastics and elastomers suitable for use in a sintered porous polymeric material, in some embodiments, are consistent with any of those described herein.

A sintered porous polymeric material of a molded article comprising at least one plastic and at least one elastomer, according to some embodiments of the present invention, comprises at least one elastomer in an amount ranging from about 10 weight percent to about 90 weight percent. In other embodiments, a sintered porous polymeric material comprises at least one elastomer in an amount ranging from about 20 weight percent to about 80 weight percent. In another embodiment, a sintered porous polymeric material comprises at least one elastomer in an amount ranging from about 30 weight percent to about 70 weight percent. In a further embodiment, a sintered porous polymeric material comprises at least one elastomer in an amount ranging from about 40 weight percent to about 60 weight percent.

A sintered porous polymeric material of a molded article comprising at least one plastic and at least one elastomer, in one embodiment, has a porosity ranging from about 10% to about 90%. In another embodiment, a sintered porous polymeric material comprising at least one plastic and at least one elastomer has a porosity ranging from about 20% to about 80% or from about 30% to about 70%. In a further embodiment, a sintered porous polymeric material comprising at least one plastic and at least one elastomer has a porosity ranging from about 40% to about 60%.

Sintered porous polymeric materials of molded articles comprising at least one plastic and at least one elastomer, according to some embodiments of the present invention, have an average pore size ranging from about from about 1 μm to about 200 μm. In other embodiments, sintered porous polymeric materials comprising at least one plastic and at least one elastomer have an average pore size ranging from about 2 μm to about 150 μm, from about 5 μm to about 100 μm, or from about 10 μm to about 50 μm. In another embodiment, a sintered porous polymeric material has an average pore size less than about 1 μm. In one embodiment, a sintered porous polymeric material comprising at least one plastic and at least one elastomer has an average pore size ranging from about 0.1 μm to about 1 μm. In a further embodiment, a sintered porous polymeric material has an average pore size greater than 200 μm. In one embodiment, a sintered porous polymeric material comprising at least one plastic and at least one elastomer has an average pore size ranging from about 200 μm to about 500 μm or from about 500 μm to about 1 mm.

Sintered porous polymeric materials of molded articles comprising at least one plastic and at least one elastomer, according to some embodiments, have a density ranging from about 0.1 g/cm³ to about 1 g/cm³. In other embodiments, a sintered porous polymeric material has a density ranging from about 0.2 g/cm³ to about 0.8 g/cm³ or from about 0.4 g/cm³ to about 0.6 g/cm³. In a further embodiment, a sintered porous polymeric material comprising at least one plastic and at least one elastomer has a density greater than about 1 g/cm³. In one embodiment, a sintered porous polymeric material comprising at least one plastic and at least one elastomer has a density less than about 0.1 g/cm³.

In some embodiments, a sintered porous polymeric material of a molded article comprising at least one plastic and at least one elastomer has a rigidity according to ASTM D747 of less than about 15 pounds. In other embodiments, a sintered porous polymeric material comprising at least one plastic and at least one elastomer has a rigidity according to ASTM D747 of less than about 10 pounds. In a further embodiment, a sintered porous polymeric material comprising at least one plastic and at least on elastomer has a rigidity according to ASTM D747 of less than about 5 pounds. In another embodiment, a sintered porous polymeric material comprising at least one plastic and at least on elastomer has a rigidity according to ASTM D747 of less than about 1 pound.

Moreover, in some embodiments, a sintered porous polymeric material of a molded article comprising at least one plastic and at least one elastomer has a tensile strength ranging from about 10 to about 5,000 psi as measured according to ASTM D638. A sintered porous polymeric material comprising at least one plastic and at least one elastomer, in some embodiments, has a tensile strength ranging from about 50 to 3000 psi or from about 100 to 1,000 psi as measured according to ASTM D638. In some embodiments, a sintered porous polymeric material comprising at least one plastic and at least one elastomer has an elongation from ranging from 10% to 500%.

In some embodiments, a sintered porous polymeric material of a molded article comprising at least one plastic and at least one elastomer further comprises at least one color change indicator. Color change indicator suitable for use in sintered porous polymeric components comprising at least one plastic and at least one elastomer, in some embodiments, are consistent with any of those provided herein.

In some embodiments, a sintered porous polymeric material of a molded article comprising at least one plastic and at least one elastomer comprises at least one color change indicator in an amount ranging from about 0.001 weight percent to about 2 weight percent. In other embodiments, a sintered porous polymeric material comprises at least one color change indicator in an amount ranging from about 0.01 weight percent to about 1 weight percent. In a further embodiment, a sintered porous polymeric material comprises at least one color change indicator in an amount ranging from about 0.05 weight percent to about 0.5 weight percent.

In some embodiments, a sintered polymeric material of a molded article comprising at least one plastic and at least one elastomer further comprises at least one super-absorbent material. Super-absorbent materials suitable for use in a sintered polymeric material comprising at least one plastic and at least one elastomer are consistent with those provided herein.

In some embodiments, a sintered porous polymeric material of a molded article comprises at least one super-absorbent material in an amount ranging from about 10 weight percent to about 90 weight percent. In other embodiments, a sintered porous polymeric material comprises at least one super-absorbent material in an amount ranging from about 20 weight percent to about 80 weight percent. In another embodiment, a sintered porous polymeric material comprises at least one super-absorbent material in an amount ranging from about 30 weight percent to about 70 weight percent. In a further embodiment, a sintered porous polymeric material comprises at least one super-absorbent material in an amount ranging from about 40 weight percent to about 60 weight percent.

Super-absorbent materials, in some embodiments, are incorporated into the sintered porous matrix of the polymeric material, the porous matrix comprising at least one plastic and at least one elastomer. In other embodiments, super-absorbent materials are located in the pores of the sintered porous polymeric material of a molded article. In one embodiment, a super-absorbent material resides in the majority of the pores of the sintered porous polymeric material of a molded article. In another embodiment, a super-absorbent material resides in the minority of pores of the sintered porous polymeric material of a molded article. In a further embodiment, super-absorbent materials are located in both the sintered porous matrix and the pores of the sintered porous polymeric material of a molded article.

In some embodiments, a sintered porous polymeric material of a molded article comprising at least one plastic and at least one elastomer further comprises at least one functional additive. Functional additives suitable for use in a sintered porous polymeric material comprising at least one plastic and at least one elastomer are consistent with any of the functional additives described herein.

In some embodiments, a sintered porous polymeric material of a molded article comprising at least one plastic and at least one elastomer comprises at least one functional additive in an amount ranging from about 10 weight percent to about 90 weight percent. In other embodiments, a sintered porous polymeric material comprises at least one functional additive in an amount ranging from about 20 weight percent to about 80 weight percent. In another embodiment, a sintered porous polymeric material comprises at least one functional additive in an amount ranging from about 30 weight percent to about 70 weight percent. In a further embodiment, a sintered porous polymeric material comprises at least one functional additive in an amount ranging from about 40 weight percent to about 60 weight percent.

Functional additives, in some embodiments, are incorporated into the sintered porous matrix of the polymeric material. In other embodiments, functional additives are located in the pores of the sintered porous polymeric material of a molded article. In one embodiment, a functional additive resides in the majority of the pores of the sintered porous polymeric material of a molded article. In another embodiment, a functional additive resides in the minority of pores of the sintered porous polymeric material of a molded article. In a further embodiment, functional additives are located in both the sintered porous matrix and the pores of the sintered porous polymeric material of a molded article.

### Sintered Polymeric Materials Comprising a Flexible Region and a Rigid Region

In some embodiments, a sintered porous polymeric material of a molded article comprises a flexible region continuous with a rigid region, wherein the flexible region comprises a first plastic and at least one elastomer and the rigid region comprises a second plastic.

In some embodiments, the first and second plastics comprise the same plastic. In other embodiments, the first and second plastics comprise different plastics. A sintered porous polymeric material of a molded article comprising a flexible region continuous with a rigid region, in some embodiments, further comprises plastics in addition to the first and second plastics. In one embodiment, for example, the flexible region comprises one or more plastics in addition to the first plastic. Moreover, the rigid region, in some embodiments, comprises one or more plastics in addition to the second plastic. Plastics suitable for use in sintered polymeric materials comprising a flexible region continuous with a rigid region, in some embodiments, are consistent with any of the plastics provided herein.

Elastomers suitable for use in sintered porous polymeric materials comprising a flexible region continuous with a rigid region, in some embodiments, comprise elastomers consistent with those provided herein.

In some embodiments, the flexible region comprises at least one elastomer in an amount ranging from about 10 weight percent to about 90 weight percent. In other embodiments, the flexible region comprises at least one elastomer in an amount ranging from about 20 weight percent to about 80 weight percent. In another embodiment, the flexible region comprises at least one elastomer in an amount ranging from about 30 weight percent to about 70 weight percent. In a further embodiment, the flexible region comprises at least one elastomer in an amount ranging from about 40 weight percent to about 60 weight percent.

In some embodiments, the flexible region comprising a first plastic and at least one elastomer has a porosity ranging from about 10% to about 90%. In another embodiment, the flexible region has a porosity ranging from about 20% to about 80% or from about 30% to about 70%. In a further embodiment, the flexible region has a porosity ranging from about 40% to about 60%.

In some embodiments, the flexible region has an average pore size ranging from about 1 μm to about 200 μm. In other embodiments, the flexible region has an average pore size ranging from about 2 μm to about 150 μm, from about 5 μm to about 100 μm or from about 10 μm to about 50 μm. In another embodiment, the flexible region has an average pore size less than about 1 μm. In one embodiment, the flexible region has an average pore size ranging from about 0.1 μm to about 1 μm. In a further embodiment, the flexible region has an average pore size greater than 200 μm. In one embodiment, the flexible region has an average pore size ranging from about 200 μm to about 500 μm or from about 500 μm to about 1 mm.

The flexible region of a continuous sintered porous polymeric component of a molded article, according to some embodiments, has a density ranging from about 0.1 g/cm³ to about 1 g/cm³. In other embodiments, the flexible region has a density ranging from about 0.2 g/cm³ to about 0.8 g/cm³ or from about 0.4 g/cm³ to about 0.6 g/cm³. In a further embodiment, the flexible region has a density greater than about 1 g/cm³. In one embodiment, the flexible region has a density less than about 0.1 g/cm³.

In some embodiments, the flexible region of a has rigidity according to ASTM D747 of less than about 15 pounds. In other embodiments, the flexible region has a rigidity according to ASTM D747 of less than about 10 pounds. In another embodiment, the flexible region has a rigidity according to ASTM D747 of less than about 5 pounds. In a further embodiment, the flexible region has a rigidity according to ASTM D747 of less than about 1 pound.

The rigid region continuous with the flexible region of a sintered porous polymeric material of a molded article, according embodiments of the present invention, comprises a second plastic. In some embodiments, the rigid region does not comprise any elastomeric materials in addition to the second plastic. In other embodiments, the rigid region comprises less than about 20 weight percent elastomer. In another embodiment, the rigid region comprises less than about 10 weight percent elastomer. In a further embodiment, the rigid region comprises less than about 5 weight percent elastomer.

In some embodiments, the rigid region has a porosity ranging from about 10% to about 90%. In other embodiments, the rigid region has a porosity ranging from about 20% to about 80% or from about 30% to about 70%. In another embodiment, the rigid region has a porosity ranging from about 40% to about 60%.

In some embodiments, the rigid region has an average pore size ranging from about 1 μm to about 200 μm. In other embodiments, the rigid region has an average pore size ranging from about 2 μm to about 150 μm, from about 5 μm to about 100 μm or from about 10 μm to about 50 μm. In another embodiment, the rigid region has an average pore size less than about 1 μm. In one embodiment, the rigid region has an average pore size ranging from about 0.1 μm to about 1 μm. In a further embodiment, the rigid region has an average pore size greater than 200 μm. In one embodiment, the rigid region has an average pore size ranging from about 200 μm to about 500 μm or from about 500 μm to about 1 mm.

The rigid region of a sintered porous polymeric material of a molded article, according to some embodiments, has a density ranging from about 0.1 g/cm³ to about 1 g/cm³. In other embodiments, the rigid region has a density ranging from about 0.2 g/cm³ to about 0.8 g/cm³ or from about 0.4 g/cm³ to about 0.6 g/cm³. In a further embodiment, the rigid region has a density greater than about 1 g/cm³. In one embodiment, the rigid region has a density less than about 0.1 g/cm³.

In some embodiments, the rigid region of a sintered porous polymeric material of a molded article has rigidity according to ASTM D747 of greater than about 15 pounds. In other embodiments, the rigid region has a rigidity according to ASTM D747 of greater than about 10 pounds. In another embodiment, the rigid region has a rigidity according to ASTM D747 of greater than about 5 pounds.

In some embodiments, the flexible region and/or rigid region of a sintered porous polymeric material of a molded article further comprises at least one color change indicator. In one embodiment, the flexible region can comprises a first color change indicator and the rigid region can comprise a second color change indicator. In some embodiments, the first and second color change indicators are the same. In other embodiments, the first and second color change indicators are different. Color change indicators suitable for use in flexible and rigid regions of sintered porous polymeric components, in some embodiments, are consistent with any of the color change indicators described herein.

In some embodiments, a flexible and/or rigid region of sintered porous polymeric component comprises at least one color change indicator in an amount ranging from about 0.001 weight percent to about 2 weight percent. In other embodiments, a flexible and/or rigid region of a sintered porous polymeric component comprises at least one color change indicator in an amount ranging from about 0.01 weight percent to about 1 weight percent. In a further embodiment, a flexible and/or rigid region of a sintered porous polymeric component comprises at least one color change indicator in an amount ranging from about 0.05 weight percent to about 0.5 weight percent.

Moreover, in some embodiments, the flexible region and/or rigid region of a sintered porous polymeric material of a molded article further comprises at least one super-absorbent material. In one embodiment, the flexible region comprises a first super-absorbent material and the rigid region comprises a second super absorbent material. In some embodiments, the first and second super-absorbent materials are the same. In other embodiments, the first and second super-absorbent materials are different. Super-absorbent materials suitable for use in flexible and rigid regions of sintered porous polymeric components, in some embodiments, are consistent with any of the super-absorbent materials described herein.

In some embodiments, the flexible and/or rigid region of a sintered porous polymeric material of a molded article comprises at least one super-absorbent material in an amount ranging from about 10 weight percent to about 90 weight percent. In other embodiments, the flexible and/or rigid region comprises at least one super-absorbent material in an amount ranging from about 20 weight percent to about 80 weight percent. In another embodiment, the flexible and/or rigid region comprises at least one super-absorbent material in an amount ranging from about 30 weight percent to about 70 weight percent. In a further embodiment, the flexible and/or rigid region comprises at least one super-absorbent material in an amount ranging from about 40 weight percent to about 60 weight percent.

In some embodiments of composite materials of the present invention, the flexible region of a molded article is in contact with an aperture or raised surface of the sheet. The flexible properties of the flexible region can facilitate interaction or engagement with surfaces of the aperture or raised surface of the sheet. Moreover, the flexible and deformable nature of the flexible region can facilitate separation or disengagement from the aperture or raised surface of the sheet.

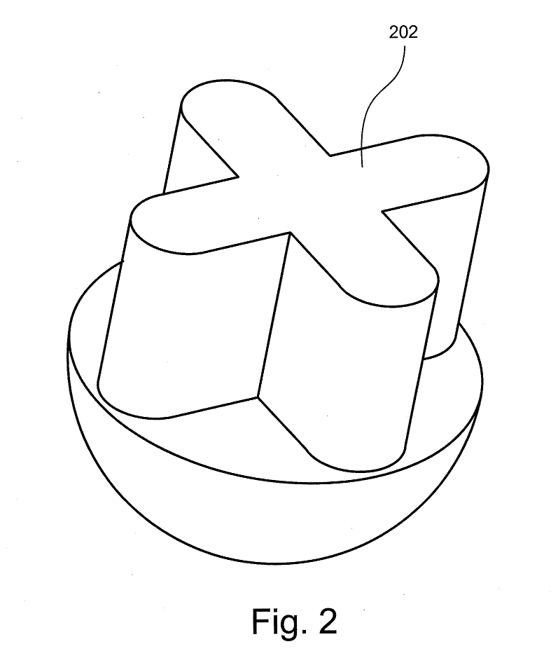

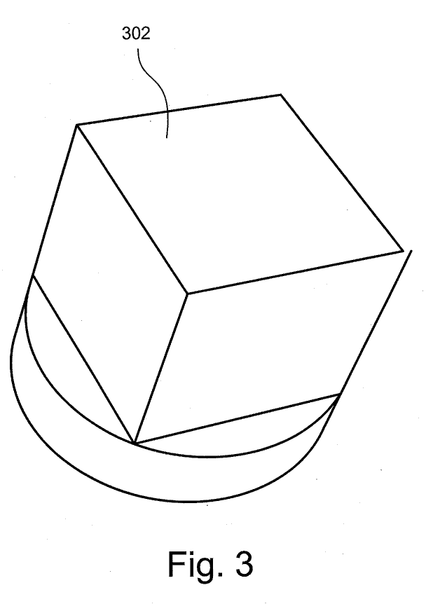

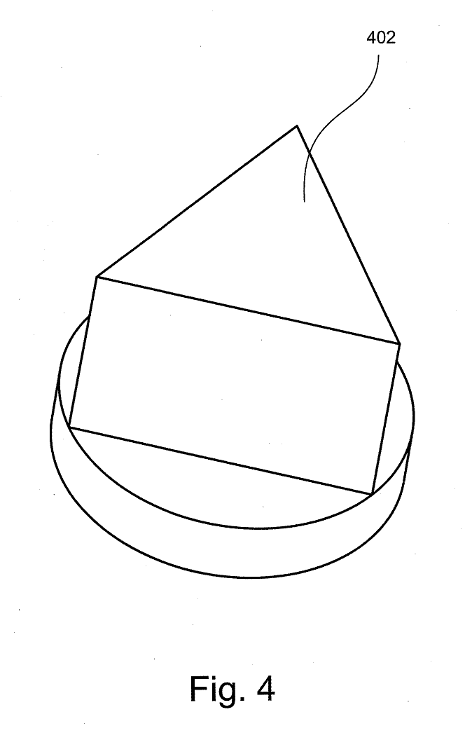

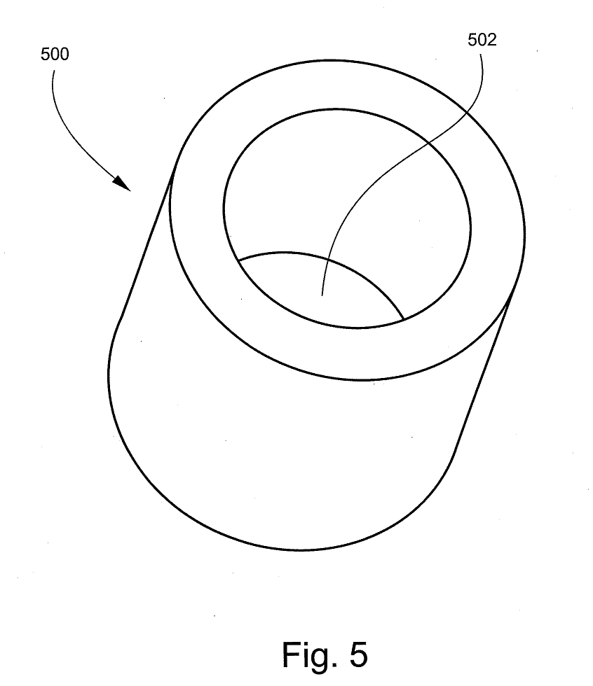

FIGS. 2 through 5 illustrate various molded articles comprising sintered porous polymeric materials for disposition in various housings according to embodiments of the present invention. Each of the molded articles in FIGS. 2 through 4 comprise a section (202, 302, and 402) for engaging the surfaces of an aperture in a sheet to dispose the molded article in the aperture. As provided herein, in some embodiments, sections (202), (302) and (402) can comprise the flexible region of a sintered porous polymeric material thereby facilitating engagement and/or separation from the aperture of a sheet. Moreover, the open volume (502) of the molded article (500) in FIG. 5 is operable to receive a raised surface of a sheet, such as a cylindrical protrusion or pin.

In another aspect, the present invention provides methods of making composite compositions of the present invention. In one embodiment, a method of making a composite composition comprises providing a sheet comprising one at least one aperture and disposing at least molded article in the at least one aperture. In some embodiments, the molded article is disposed in the aperture in an proper orientation for insertion into a housing.

Disposing a molded article in an aperture of a sheet, according to one embodiment, comprises forming the molded article in the aperture. Forming a molded article in an aperture of a sheet, in some embodiments, comprises providing a first mold comprising a first cavity and filling the first cavity with a first moldable material. The aperture of the sheet is aligned with the first cavity and a second mold comprising a second cavity is provided. The second cavity of the second mold is aligned with the first cavity and is filled with a second moldable material. After filling the second cavity, the molded article is formed in or through the aperture of the sheet. The sheet comprising the aperture, according to the present embodiment, comprises a material sufficient to withstand melting or any other degradative process produced by the molding of the molded article. In some embodiments, the molded article is formed in the aperture of the sheet in the proper orientation for placement into a housing.

In some embodiments, the first and/or second moldable materials contact surfaces of the sheet proximate the aperture. The first and/or second moldable materials, in some embodiments, do not adhere to, fuse, or otherwise react with surfaces of the sheet proximate the aperture during the molding process. In one embodiment, for example, wherein the first and/or second moldable materials comprise sinterable polymeric particles, the sheet comprises a material having a melting point in excess of that of the polymeric particles. As a result, during the molding process in which the first and second polymeric particles are sintered, the sheet does not co-sinter with the first and/or second polymeric particles. Such an arrangement precludes surfaces of the sheet from being molded into or fused to the molded article.

In another embodiment, the first and/or second moldable materials do not come into contact with surfaces of the sheet proximate the aperture. The design of the first and/or second mold can permit contact of the first and second moldable materials while precluding the first and second moldable materials from contacting surfaces of the sheet. Such an arrangement precludes surfaces of the sheet from being molded into or fused the molded article.

In some embodiments, the first moldable material and the second moldable material are the same. In other embodiments, the first moldable material and the second moldable material are different. In one embodiment, the first moldable material comprises a first polymeric material, and the second moldable material comprises a second polymeric material. In some embodiments, as provided herein, the first and second moldable materials comprise polymeric particles for sintering during the molding process. In some embodiments, the first moldable material comprises particles of a first polymeric material, and the second moldable material comprises particles of a second moldable material. In some embodiments, polymeric particles of the first and second moldable materials have the same or substantially the same average particle size. In other embodiments, polymeric particles of the first and second moldable materials have different average particle sizes.

Any of the sintered porous polymeric materials described herein for molded articles can be produced according to the methods of the present invention.

In one embodiment, for example, particles of a first polymeric material are provided in the first cavity of the first mold and a polyester sheet is aligned with the first cavity. The second cavity is of the second mold is aligned with the first cavity and filled with particles of a second polymeric material. The first and second molds are heated to sinter the first and second polymeric particles to form a continuous porous polymeric article disposed in the aperture of the polyester sheet.

In another embodiment, disposing a molded article in an aperture of a sheet comprises forming the molded article in a mold, the mold comprising a first cavity and a second cavity, removing the first or second cavity to expose a section of the molded article, and positioning the aperture of the sheet around the exposed section of the molded article. Forming the molded article, according to the present embodiment, can comprise filling the first cavity with a first moldable material, filling the second cavity with a second moldable material, and molding the first and second moldable materials.

In some embodiments wherein the aperture of the sheet is placed around the molded article after molding, the sheet is not required to demonstrate any heat resistant or other degradation resistant properties as the sheet is not in contact with the mold during the molding process. Moreover, in some embodiments, the sheet comprising at least one aperture may have elastomeric properties to permit deformation of the sheet and aperture to facilitate placement of the aperture around the molded article.

As provided herein, disposing the molded article in the aperture of sheet while still in the mold by molding the article in the aperture or placing the aperture around the molded article, in some embodiments, provides the molded article with the proper orientation for subsequent placement into a housing. Moreover, disposing the molded article in the aperture of a sheet while still in the mold facilitates removal of the molded article from the mold. As the molded article is disposed in the aperture of the sheet by mechanical engagement, the sheet can be pulled from the mold to remove the articles from the mold cavities.

In some embodiments, a plurality of molded articles can be simultaneously disposed in a plurality of apertures in a sheet. A mold, in one embodiment, for example, can display an array of cavities for the formation of a plurality of molded articles. A sheet having a plurality of apertures corresponding to the array of cavities is utilized for the simultaneous disposition of the plurality of molded articles in the apertures.

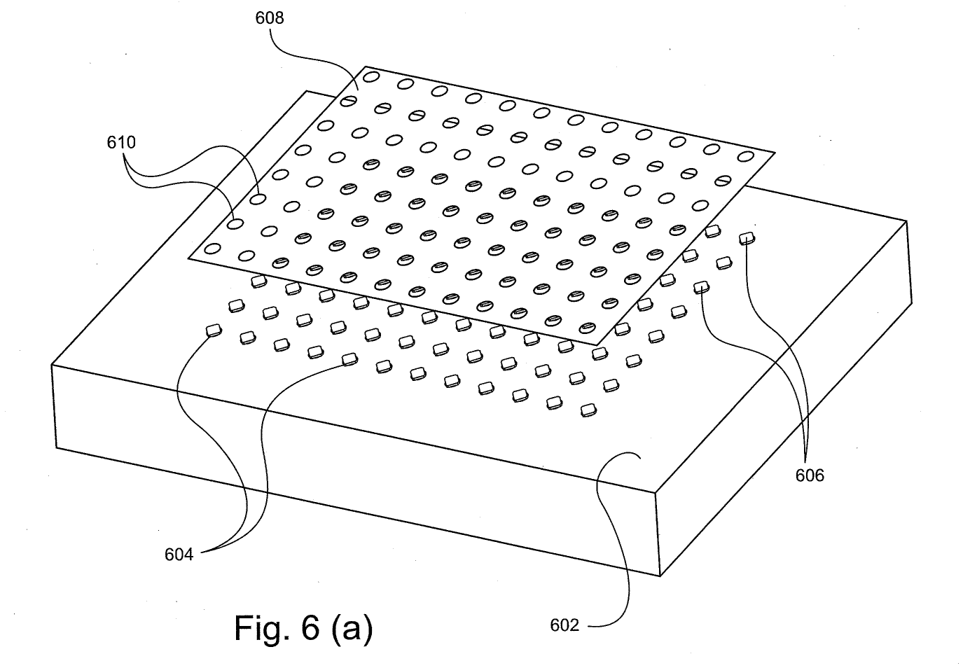

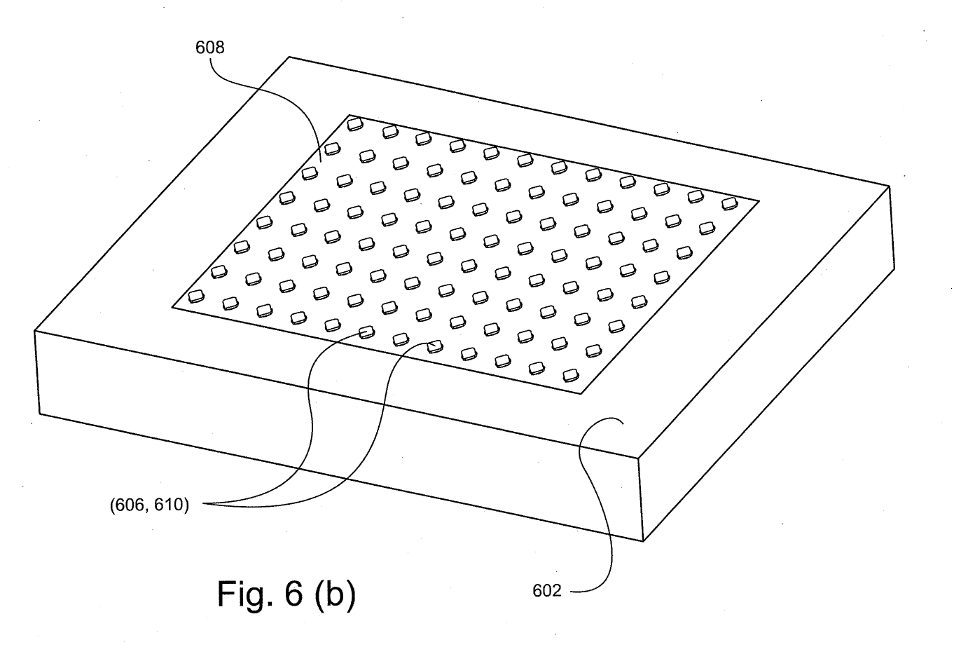

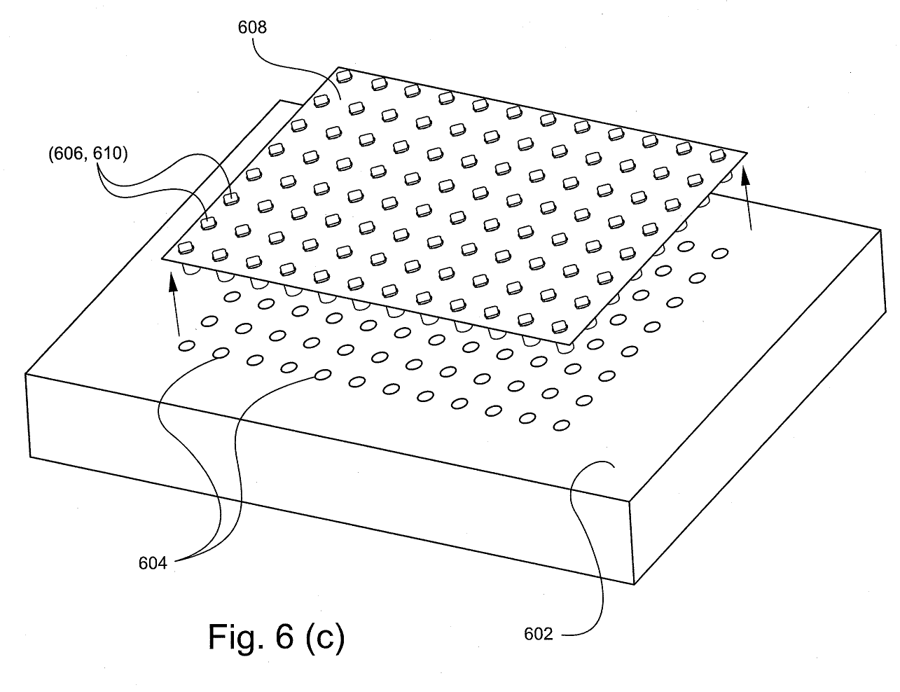

FIGS. 6(a)-(c) demonstrate a method of producing a composite composition according to one embodiment of the present invention. FIG. 6(a) provides a mold (602) having an array of first cavities (604) wherein each of the first cavities (604) has a molded article (606) disposed therein. The mold (602) additionally comprises an array of second cavities (not shown) corresponding to the array of first cavities (602) for producing the molded articles (606). The molded articles (606) are produced by filling the first cavities (604) with a first moldable material and filling the second cavities (not shown) with a second moldable material and forming the molded articles (606). After forming the molded articles (606), the array of second cavities (not shown) are removed to expose at segment of the molded articles (606). A sheet (608) comprising an array of apertures (610) is provided. The array of apertures (610) in the sheet correspond to the array of first cavities (604) of the mold (602).

As illustrated in FIG. 6(b), the sheet (608) is laid down over the mold (602) thereby positioning the apertures (610) in the sheet (608) around the exposed sections of the molded articles (606). Once the apertures (610) are positioned around and engaged with the molded articles (606), the sheet (608) is lifted off the mold (602) thereby removing the molded articles (606) from the array of first cavities (604). Removal of the molded articles (606) from the array of first cavities (604) is illustrated in FIG. 6(c).

Additionally, in some embodiments, methods of making composite compositions of the present invention can be continuous. A section of a continuous sheet comprising an array of apertures corresponding to an array of cavities in a mold is provided. The molded articles are disposed in the apertures of the section of the continuous sheet according to the methods described herein. The section comprising the apertures with molded articles disposed therein is subsequently advanced from the mold, and a new section of the continuous sheet comprising the array of apertures is presented for disposing newly molded articles in the array of apertures. The foregoing process can be repeated any number of times. The resulting continuous sheet comprising a continuous array of apertures having molded articles disposed therein can be rolled into a roll or cut into sections for stacking.

In another embodiment, a method of making a composite composition comprises providing a sheet comprising at least one raised surface, forming a molded article in a mold comprising a first cavity, and associating the at least one raised surface with the at least one molded article. Associating the at least one raised surface with the at least one molded article, in some embodiments, comprises mechanically engaging the molded article with the raised surface. In one embodiment, for example, a raised surface of the sheet comprises a cylindrical protrusion or pin. The cylindrical protrusion is operable to mechanically engage a cylindrical depression in the molded article. The mechanical engagement between the protrusion and depression may be a friction fit.

In some embodiments, a plurality of molded articles can be simultaneously associated with a plurality of raised surfaces in a sheet. A mold, in one embodiment, for example, can display an array of cavities for the formation of a plurality of molded articles, and a sheet can demonstrate a plurality of raised surfaces corresponding to the array of cavities. The plurality of raised surfaces are simultaneously brought into contact with the plurality of molded articles to form a composition of the present invention. Moreover, the foregoing process can be continuous wherein segments of a continuous sheet of raised surfaces are sequentially brought into contact with newly molded articles. As provided herein, the continuous sheet of raised surfaces and associated molded articles can be subsequently rolled or cut into individual segments and stacked.

Associating a molded article with a raised surface of a sheet while still in the mold, in some embodiments, provides the molded article with the proper orientation for subsequent placement into a housing. Moreover, associating a molded article with the raised surface of a sheet while still in the mold facilitates removal of the molded article from the mold. As the molded article can be associated with a raised surface of the sheet by mechanical engagement, the sheet can be pulled from the mold to remove the articles from the mold cavities.

In a further aspect, the present invention provides methods of disposing a molded article in a housing. In one embodiment, a method of disposing a molded article in a housing comprises providing a composition comprising a sheet comprising at least one aperture and at least one molded article, wherein the molded article is at least partially disposed in the at least one aperture. The aperture and the molded article disposed therein are aligned with an opening of a housing and the molded article is separated or disengaged from the aperture for disposition in the housing. In some embodiments, the molded article is separated or disengaged from the aperture in the sheet by pushing or pulling the molded article.

In another embodiment, methods of the present invention provide for the disposition of a plurality of molded articles into a plurality of housings. As provided herein, in some embodiments, a sheet comprises a plurality of apertures, wherein each of the plurality of apertures comprises a molded article disposed therein. The plurality of apertures and plurality of associated molded articles are aligned with a plurality of housings. The plurality of molded articles are separated or disengaged from the apertures for disposition in the housings. In some embodiments, the plurality of molded articles are disposed in the plurality of housings simultaneously. In other embodiments, the plurality of molded articles are disposed in the plurality of housings sequentially of serially.

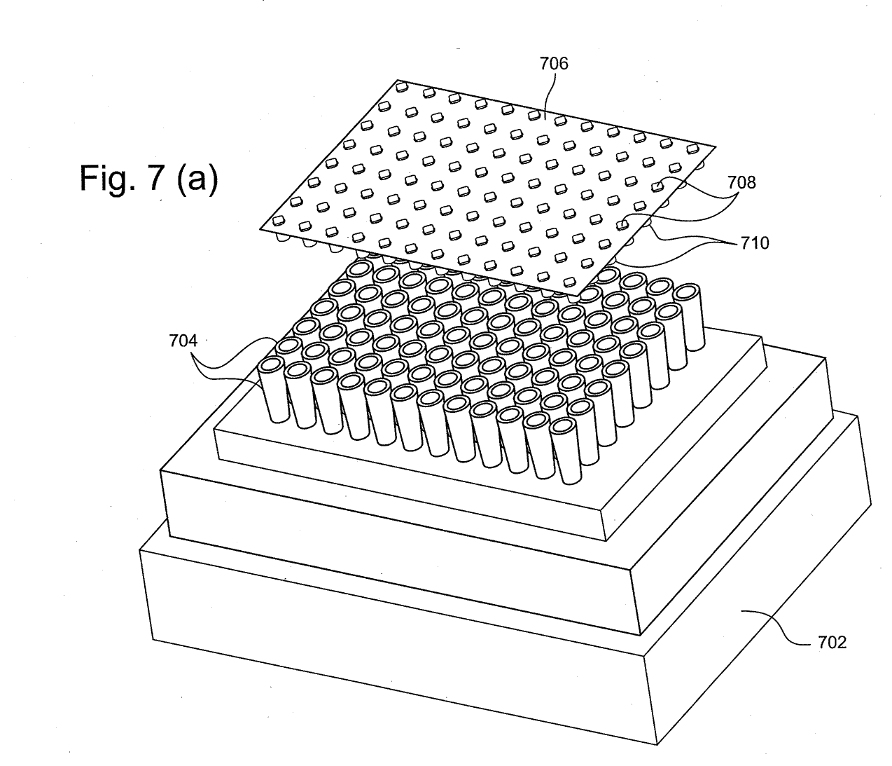

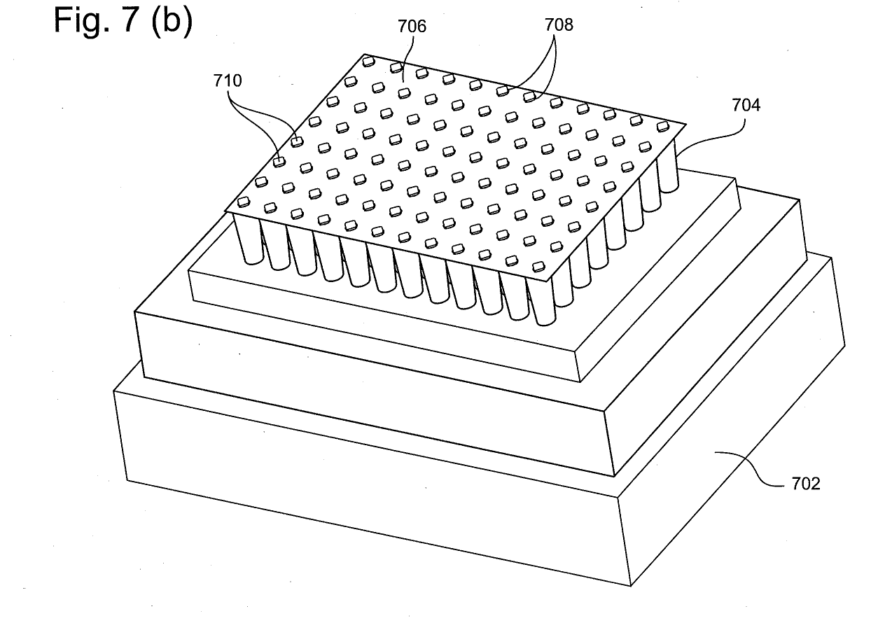

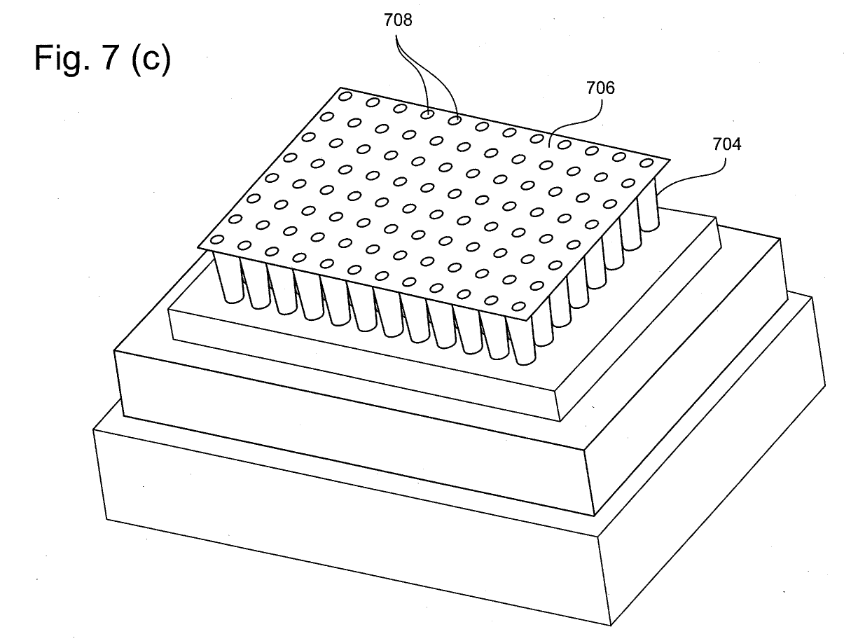

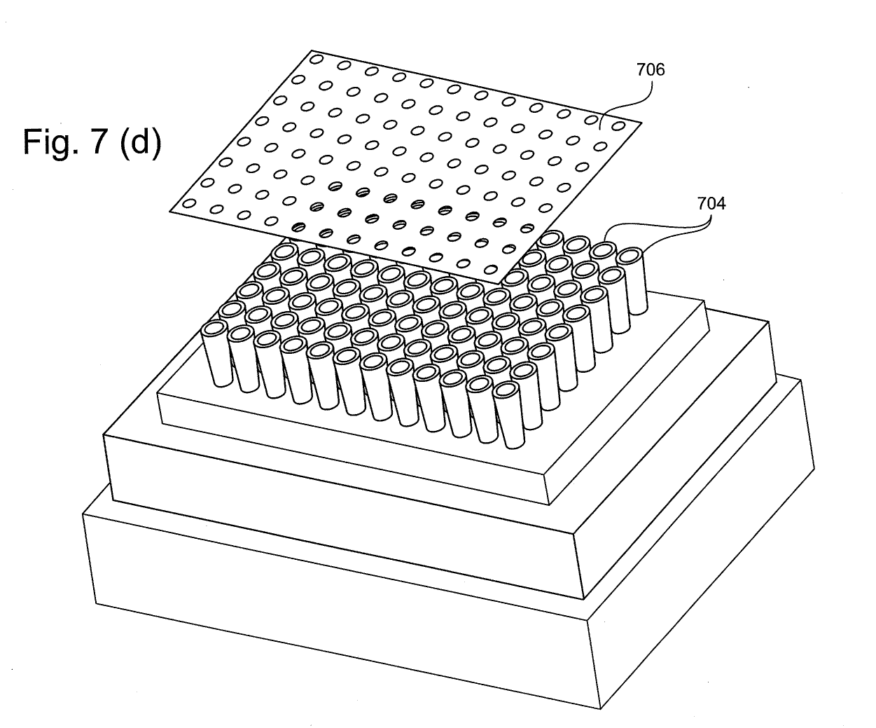

FIGS. 7(a)-(d) illustrate a method of disposing a molded article in a housing according to one embodiment of the present invention. FIG. 7(a) provides a pipette tip rack (702) comprising an array of pipette tips (704). FIG. 7(a) additionally illustrates a composite composition (704), according to one embodiment of the present invention, comprising a sheet (706) having an array of apertures (708), wherein each aperture (708) has a molded article (710) disposed therein. The array of apertures (708) mirrors the array of pipette tips (704) in the rack (702). As illustrated in FIG. 7(b), the sheet (706) comprising the array of apertures (708) is aligned over the array of pipette tips (704) such that each pipette tip (704) corresponds to an aperture (708) having a molded article (710) disposed therein. The molded articles (710) are then disengaged or separated from the apertures (708) and are disposed or seated in the pipette tips (704), as illustrated in FIG. 7(c). The disengagement of the plurality of molded articles (710) can be simultaneous or sequential. The disengagement or separation of the molded articles (710) can be effectuated by applying sufficient force to the molded articles (710) to dislodge the molded articles (710) from the apertures (708). In an alternative embodiment, the apertures (708) can be deformed by placing the sheet (706) in tension or compression to separate the molded articles (708) from the apertures (710). After disposition of the molded articles (710) in the pipette tips (704), the sheet (706) is removed from the pipette tips (704), as illustrated in FIG. 7(d).

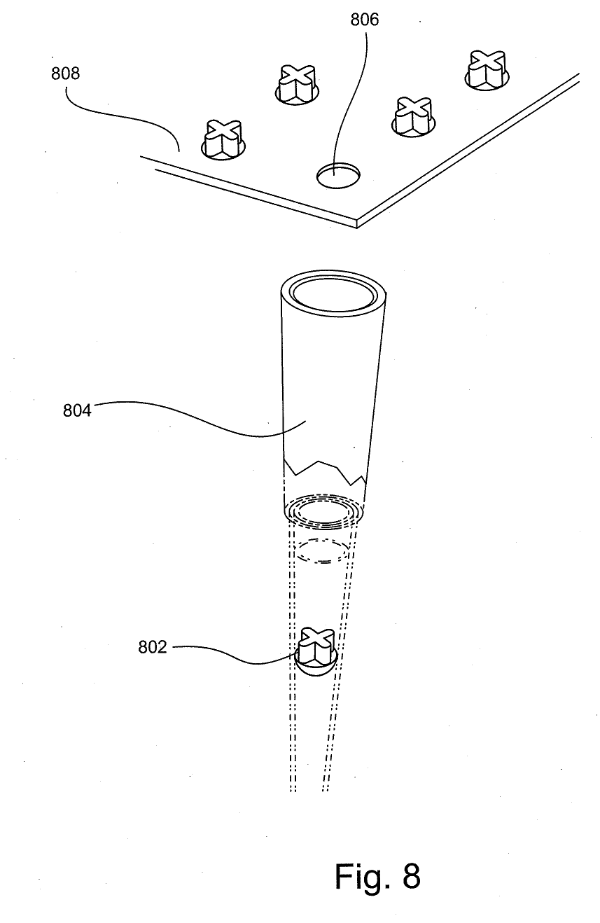

FIG. 8 illustrates a molded article (802) disposed in a pipette tip (804) according to one embodiment of the present invention. As shown in FIG. 8, the molded article (802) has been separated from the corresponding aperture (806) in the sheet (808) and is seated in the pipette tip (804). Moreover, disposition of the molded article (802) in the aperture (806) of the sheet (808) provides the molded article (802) with the proper orientation for placement in the pipette tip (804).

In another aspect, a method of disposing a molded article in a housing comprises providing a composition comprising a sheet comprising at least one raised surface and at least one molded article associated with the raised surface and aligning the raised surface and molded article with an opening of a housing. Following alignment, the molded article is separated or disengaged from the raised surface of the sheet for disposition in the housing. Separation or disengagement of the molded article from the raised surface can comprise pushing or pulling the molded article from the raised surface.

Moreover, a plurality of molded articles, in some embodiments, can be disposed in a plurality of housings. In one embodiment, a sheet comprises a plurality of raised surfaces, wherein each raised surface has a molded article associated therewith. The plurality of raised surfaces and molded articles are aligned with a plurality of housings, and the molded articles are separated from the raised surfaces for disposition in the plurality of housings.

As provided herein, in some embodiments, molded articles having anisotropic shapes, heterogeneous compositions, and/or heterogeneous physical properties can be provided the proper orientation for placement into a housing when the molded article is disposed in an aperture of a sheet or otherwise associated with a raised surface of the sheet. The preorientation of the molded article in the sheet prior to placement in a housing precludes the disadvantages associated with hand orienting mold articles for placement thereby freeing manufacturers to design molded articles with complicated shapes, compositions, and properties to match the demands of various end use applications.

Housings, according to some embodiments of the present invention, comprise pipette tips, syringes, tubes, well plates such as a 96-well plate, separation columns, or filter housings.

Embodiments of the present invention a further illustrated in the following non-limiting examples.

### EXAMPLE 1

### Composite Composition

UHMWPE (Ticona) powder with an average particle size of about 150 μm was filled into a plurality of cylinder shaped (4 mm diameter, 5 mm deep) cavities in a first aluminum mold. A die cut polyethylene terephthalate (MYLAR®) sheet (0.005″ thick) having a plurality of round apertures (3.5 mm diameter) positionally correlated with the cavities of the first mold was placed on top of the first mold. A second aluminum mold with square-shaped cavities (3 mm wide, 2 mm deep) was placed on top of the MYLAR® sheet. The square-shaped cavities of the second mold were positionally correlated with the cylinder-shaped cavities of the first mold and the apertures of the MYLAR® sheet. UHMWPE powder (Ticona) was filled into the cavities of the second mold with vibration. The combined mold was heated to 360° F. for five minutes and then cooled to room temperature in five minutes thereby forming the molded articles in the apertures of the MYLAR® sheet. The second mold was removed, and the composite composition comprising the MYLAR® sheet comprising a plurality of apertures, each aperture having a molded article disposed therein was removed from the first mold by pulling the MYLAR® sheet from the mold. The MYLAR® sheet and sintered porous UHMWPE molded articles were engaged but not fused together. The sintered UHMWPE molded articles had open pore structure with average pore size around 35 microns and 40% porosity.

### EXAMPLE 2

### Composite Material

UHMWPE (Ticona) powder with an average particle size of about 150 μm was filled into a plurality of cylinder shaped (4 mm diameter, 5 mm deep) cavities in a first aluminum mold. A die cut polyethylene terephthalate (MYLAR®) sheet (0.005″ thick) having a plurality of round apertures (3.5 mm diameter) positionally correlated with the cavities of the first mold was placed on top of the first mold. A second aluminum mold with square-shaped cavities (3 mm wide, 2 mm deep) was placed on top of the MYLAR® sheet. The square-shaped cavities of the second mold were positionally correlated with the cylinder-shaped cavities of the first mold and the apertures of the MYLAR® sheet. A powder mixture comprising 70% UHMWPE powder (average particle size about 150 μm) and 30% Kraton elastomer (Kraton Polymers US, LLC) particles (average particle size about 150 μm) was filled into the cavities of the second mold with vibration. The combined mold was heated to 360° F. for five minutes and then cooled to room temperature in five minutes thereby forming the molded articles in the apertures of the MYLAR® sheet. The second mold was removed, and the composite composition comprising the MYLAR® sheet comprising a plurality of apertures, each aperture having a molded article disposed therein was removed from the first mold by pulling the MYLAR® sheet from the mold. The MYLAR® sheet and sintered porous UHMWPE molded articles were engaged but not fused together. The sintered UHMWPE molded articles had open pore structure with average pore size around 35 microns and 40% porosity.

### EXAMPLE 3

### Composite Composition

UHMWPE (Ticona) powder with an average particle size of about 150 μm was filled into a plurality of cylinder shaped (4 mm diameter, 5 mm deep) cavities in a first aluminum mold. A second aluminum mold with square-shaped cavities (3 mm wide, 2 mm deep) was placed on top of the first mold. The cavities of the second mold were positionally correlated to the cavities in the first mold. UHMWPE powder (Ticona) was filled into the cavities of the second mold with vibration. The combined mold was heated to 360° F. for five minutes and then cooling to room temperature in five minutes to form the molded articles. The second mold was removed and a die cut MYLAR® sheet (0.005″ thick) with round apertures (3.5 mm diameter) positionally correlated with the cavities in the first and second molds was provided. The MYLAR® sheet was placed on the first mold permitting the square sections of the molded article to be pushed through the round apertures of the MYLAR® sheet. The resulting composite composition comprising a MYLAR® sheet comprising a plurality of apertures, each aperture having a sintered porous molded article therein was removed from the first mold by pulling the MYLAR® sheet from the mold. The sintered UHMWPE molded articles demonstrated an open pore structure with average pore size around 35 microns and 40% porosity.

### EXAMPLE 4

### Composite Composition

UHMWPE (Ticona) powder with an average particle size of about 150 μm was filled into a plurality of cylinder shaped (4 mm diameter, 5 mm deep) cavities in a first aluminum mold. A second aluminum mold with square-shaped cavities (3 mm wide, 2 mm deep) was placed on top of the first mold. The cavities of the second mold were positionally correlated to the cavities in the first mold. UHMWPE powder (Ticona) was filled into the cavities of the second mold with vibration. The combined mold was heated to 360° F. for five minutes and then cooling to room temperature in five minutes to form the molded articles. The second mold was removed and a die cut die cut polyethylene film (0.005″ thick) with round apertures (3.5 mm diameter) positionally correlated with the cavities in the first and second molds was provided. The polyethylene film was placed on the first mold permitting the square sections of the molded article to be pushed through the round apertures of the polyethylene film. The resulting composite composition comprising a polyethylene film comprising a plurality of apertures, each aperture having a sintered porous molded article therein was removed from the first mold by pulling the polyethylene sheet from the mold. The sintered UHMWPE molded articles demonstrated an open pore structure with average pore size around 35 microns and 40% porosity.

### EXAMPLE 5

### Composite Composition

HDPE powder with an average particle size of about 150 μm is filled into a plurality of cylinder shaped (4 mm diameter, 5 mm deep) cavities in a first aluminum mold. A die cut polyethylene terephthalate (MYLAR®) sheet (0.005″ thick) having a plurality of round apertures (3.5 mm diameter) positionally correlated with the cavities of the first mold is placed on top of the first mold. A second aluminum mold with square-shaped cavities (3 mm wide, 2 mm deep) is placed on top of the MYLAR® sheet. The square-shaped cavities of the second mold are positionally correlated with the cylinder-shaped cavities of the first mold and the apertures of the MYLAR® sheet. HDPE powder is filled into the cavities of the second mold with vibration. The combined mold is heated to 340° F. for three minutes and is then cooled to room temperature in five minutes thereby forming the molded articles in the apertures of the MYLAR® sheet. The second mold is removed, and the composite composition comprising the MYLAR® sheet comprising a plurality of apertures, each aperture having a molded article disposed therein is removed from the first mold by pulling the MYLAR® sheet from the mold. The MYLAR® sheet and sintered porous HDPE molded articles are engaged but not fused together. The sintered UHMWPE molded articles display an open pore structure with average pore size around 35 microns and 40% porosity.

All patents, publications and abstracts cited above are incorporated herein by reference in their entirety. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A composite composition comprising:
a sheet comprising at least one aperture; and
at least one molded porous article at least partially disposed in the aperture in a proper orientation for placement in a housing.

2. The composite composition of claim 1, wherein the at least one molded porous article has an anisotropic shape.

3. The composite composition of claim 1, wherein the at least one molded porous article comprises a polymeric article.

4. The composite composition of claim 3, wherein the polymeric article comprises a polyolefin, polyamide, polyester, rigid polyurethane, polyacrylonitrile, polycarbonate, polyvinylchloride, polymethylmethacrylate, polyvinylidene fluoride polytetrafluoroethylene, polyethersulfone, polystyrene, polyether imide, polyetheretherketone, or polysulfone or mixtures of copolymers thereof.

5. The composite composition of claim 3, wherein the polymeric article is a sintered polymeric article.

6. The composite composition of claim 4, wherein the polyolefin comprises polyethylene, polypropylene or copolymers thereof.

7. The composite composition of claim 6, wherein the polyethylene comprises high density polyethylene or ultrahigh molecular weight polyethylene.

8. The composite composition of claim 1, wherein the molded porous article has an average pore size ranging from about 1 μm to about 200 μm.

9. The composite composition of claim 1, wherein the at least one molded porous article comprises a filter, a barrier medium or a combination thereof.

10. The composite composition of claim 1, wherein the sheet has a thickness ranging from about 1 mil to about 50 mil.

11. The composite composition of claim 1, wherein the sheet comprises a plurality of apertures.

12. The composite composition of claim 11, wherein the plurality of apertures comprises an array of apertures.

13. The composite composition of claim 1, wherein the sheet comprises a polymeric material, paper, or metal or combinations thereof.

14. The composite composition of claim 1, wherein the housing comprises a pipette tip, syringe, separation column, filter housing, or a well plate.

15. A composite composition comprising:
a sheet comprising at least one raised surface; and
at least one molded porous article,
wherein the at least one molded porous article is associated with the raised surface in a proper orientation for placement in a housing.

16. The composite composition of claim 15, wherein the at least one molded porous article has an anisotropic shape.

17. The composite composition of claim 15, wherein the at least one molded porous article is associated with the at least one raised surface by mechanical engagement.

18. The composite composition of claim 15, wherein the at least one molded porous article comprises a filter, a barrier medium or a combination thereof.

19. The composite composition of claim 15, wherein the housing comprises a pipette tip, syringe, separation column, filter housing or a well plate.

20. The composite composition of claim 15, wherein the raised surface comprises a protrusion or a pin adapted to mechanically engage the at least one molded porous article.

21. The composite composition of claim 15, wherein the sheet comprises a plurality of raised surfaces.

22. The composite composition of claim 21, wherein the plurality of raised surfaces comprises an array of raised surfaces.

23. A method of making a composite composition comprising:
providing a sheet comprising at least one aperture; and
disposing at least one molded porous article in the at least one aperture in a proper orientation for placement in a housing.

24. The method of claim 23, wherein disposing the at least one molded porous article in the at least one aperture comprises:
providing a first mold comprising a first cavity;
filling the first cavity with a first moldable material;
aligning the at least one aperture of the sheet with the first cavity;
providing a second mold comprising a second cavity;
aligning the second cavity with the at least one aperture of the sheet;
filling the second cavity with a second moldable material; and
molding the first moldable material and the second moldable material to form the molded porous article.

25. The method of claim 24, wherein the first moldable material comprises a first polymeric material, and the second moldable material comprises a second polymeric material.

26. The method of claim 25, wherein the first and the second polymeric materials comprise particles.

27. The method of claim 26, wherein particles of the first polymeric material have an average size different than particles of the second polymeric material.

28. The method of claim 25, wherein the first and the second polymeric materials are the same.

29. The method of claim 23 wherein the molded porous article comprises a porosity gradient.

30. The method of claim 24, wherein molding comprises sintering the first moldable material and the second moldable material.

31. The method of claim 23, wherein the sheet comprises a plurality of apertures.

32. A method of making a composite composition comprising:
providing a sheet comprising at least one raised surface;
forming at least one molded porous article in a mold comprising a cavity; and
associating the at least one molded porous article with the at least one raised surface in a proper orientation for placement in a housing.

33. The method of claim 32, wherein associating the at least one molded porous article with the at least one raised surface comprises mechanically engaging the molded porous article with the raised surface.

34. The method of claim 33, wherein the at least one raised surface comprises a protrusion or a pin.

35. The method of claim 32, wherein the sheet has a thickness ranging from about 1 mil to about 50 mil.

36. A method of disposing a molded article in a housing comprising:
providing a composition comprising a sheet comprising at least one aperture and at least one molded porous article disposed in the aperture in a proper orientation for placement in the housing;
aligning the aperture and the molded porous article with an opening of the housing; and
separating the molded porous article from the aperture.

37. The method of claim 36, wherein separating the molded porous article from the aperture comprises pushing or pulling the molded porous article from the aperture.

38. The method of claim 36, wherein the at least one molded porous article comprises a filter, a barrier medium or a combination thereof.

39. The method of claim 38, wherein the housing comprises a pipette tip, syringe, separation column, filter housing or a well plate.

40. The method of claim 36, wherein the sheet has a thickness ranging from about 1 mil to about 50 mil.
